(19) United States
(12) Patent Application Publication
(10) Pub. No.: US 2025/0115127 A1
(43) Pub. Date: Apr. 10, 2025

(54) CONTENT PROCESSING SYSTEM, CONTENT GENERATING DEVICE, AND CONTENT PLAYBACK DEVICE

(71) Applicant: TOYOTA BOSHOKU KABUSHIKI KAISHA, Aichi (JP)

(72) Inventors: Nobuki HAYASHI, Aichi (JP); Osamu KAWASE, Aichi (JP); Tetsuro SAKAGUCHI, Aichi (JP)

(73) Assignee: TOYOTA BOSHOKU KABUSHIKI KAISHA, Aichi (JP)

(21) Appl. No.: 18/809,574

(22) Filed: Aug. 20, 2024

(30) Foreign Application Priority Data
Oct. 10, 2023 (JP) 2023-175468

(51) Int. Cl. B60K 35/28; B60K 35/10

(52) U.S. Cl. CPC B60K 35/28; B60K 35/10

(57) ABSTRACT

A content generating device generates, on the basis of information relating to an internal space of a vehicle and information relating to traveling of the vehicle, content corresponding to a scene which changes as the vehicle travels.

This Nonprovisional application claims priority under 35 U.S.C. § 119 on Patent Application No. 2023-175468 filed in Japan on Oct. 10, 2023, the entire contents of which are hereby incorporated by reference.

### TECHNICAL FIELD

The present disclosure relates to a content processing system, a content generating device, and a content playback device.

### BACKGROUND ART

There has been known a conventional invention that generates content allowing a user to experience virtual reality (VR) or augmented reality (AR) in accordance with movement of a moving body and causes, in the content, a physical event linked to a scene outside the moving body (for example, Patent Literature 1).

### CITATION LIST

### Patent Literature

### [Patent Literature 1]

Japanese Patent Application Publication, Tokukai, No. 2020-103782

### SUMMARY OF INVENTION

### Technical Problem

According to the invention disclosed in Patent Literature 1, the content is generated with use of an image transmitted from a camera in real time. That is, according to the invention disclosed in Patent

Literature 1, in order to generate the content, it is necessary to run an actual moving body. Thus, the invention disclosed in Patent Literature 1 involves high cost for generating content.

An aspect of the present disclosure has an object to reduce the cost for generating content.

### Solution to Problem

In order to attain the above object, a content processing system in accordance with an aspect of the present disclosure includes: a content generating device; a storage device; and a content playback device which is to be mounted on a moving body, the content generating device being configured to: obtain information relating to an internal space of the moving body; obtain information relating to traveling of the moving body; generate, on a basis of the information relating to the internal space and the information relating to traveling, content corresponding to a scene which changes as the moving body travels; and store the generated content in the storage device, and the content playback device being configured to: obtain the information relating to the internal space of the moving body; obtain the information relating to traveling of the moving body; obtain, from the storage device, the content corresponding to the information relating to the internal space and the information relating to traveling; and play back the obtained content.

In order to attain the above object, a content generating device in accordance with an aspect of the present disclosure includes a processor, the processor being configured to: obtain information relating to an internal space of an external moving body; obtain information relating to traveling of the external moving body; generate, on a basis of the information relating to the internal space and the information relating to traveling, corresponding to a scene which changes as the external moving body travels; and store the generated content in an external storage device.

In order to attain the above object, a content playback device in accordance with an aspect of the present disclosure is a content playback device which is to be mounted on a moving body, the content playback device including a processor, the processor being configured to: obtain information relating to an internal space of the moving body; obtain information relating to traveling of the moving body; obtain, from an external storage device, content corresponding to the information relating to the internal space and the information relating to traveling; and play back the obtained content.

A content generating device and a content playback device in accordance with each aspect of the present disclosure may be realized by a computer. In such a case, the present disclosure encompasses: a control program for causing a computer to operate as the foregoing parts (software elements) of the content generating device and the content playback device so that the content generating device and the content playback device can be realized by the computer; and a computer-readable storage medium storing the control program therein.

### Advantageous Effects of Invention

In accordance with an aspect of the present disclosure, it is possible to reduce cost for generating content.

### BRIEF DESCRIPTION OF DRAWINGS

FIG. 1 is a schematic block diagram illustrating an example of a content processing system in accordance with a first embodiment of the present disclosure.

FIG. 2 is a block diagram illustrating an example of a configuration of hardware in a content generating device in accordance with the first embodiment of the present disclosure.

FIG. 3 is a block diagram illustrating an example of a configuration of hardware in a server in accordance with the first embodiment of the present disclosure.

FIG. 4 is a block diagram illustrating an example of a configuration of hardware mounted on a vehicle in accordance with the first embodiment of the present disclosure.

FIG. 5 is a functional block diagram of a processor of the content generating device in accordance with the first embodiment of the present disclosure.

FIG. 6 shows a simulation screen showing simulation of a part of an internal space of the vehicle in accordance with the first embodiment of the present disclosure.

FIG. 7 shows another example of the simulation screen.

FIG. 8 is a functional block diagram of a processor of the vehicle in accordance with the first embodiment of the present disclosure.

FIG. 9 is a view illustrating a relation between pieces of content for respective points.

FIG. 10 is a sequence chart illustrating an example of content processing carried out between the content generating device, the server, and the vehicle in accordance with the first embodiment of the present disclosure.

FIG. 11 is a block diagram illustrating an example of a configuration of hardware mounted on a vehicle in accordance with a second embodiment of the present disclosure.

FIG. 12 is a functional block diagram of a processor of the vehicle in accordance with the second embodiment of the present disclosure.

FIG. 13 is a block diagram illustrating an example of a configuration of hardware mounted on a vehicle in accordance with a third embodiment of the present disclosure.

FIG. 14 is a functional block diagram of a processor of the vehicle in accordance with the third embodiment of the present disclosure.

FIG. 15 is a block diagram illustrating an example of a configuration of hardware mounted on a vehicle in accordance with a fourth embodiment of the present disclosure.

FIG. 16 is a functional block diagram of a processor of the vehicle in accordance with the fourth embodiment of the present disclosure.

### DESCRIPTION OF EMBODIMENTS

### First Embodiment

The following will describe, with reference to the drawings, details of a content processing system 100 in accordance with a first embodiment of the present disclosure. The same parts in the drawings are given the same reference numerals, and descriptions thereof will be omitted.

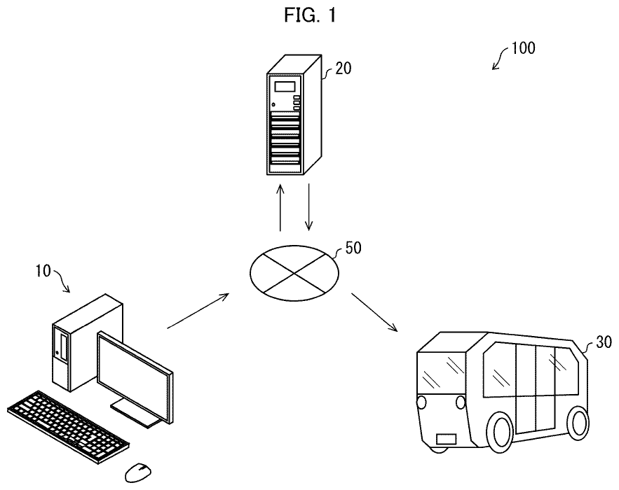

As shown in FIG. 1, the content processing system 100 includes a content generating device 10, a server 20, and a vehicle 30. FIG. 1 illustrates a single content generating device, a single server, and a single vehicle. However, each of the number of content generating devices, the number of servers, and the number of vehicles is not limited to one. The content processing system 100 may include a plurality of content generating devices, a plurality of servers, and a plurality of vehicles. In one example of operation of the content processing system 100 configured as above, content to be played back in an internal space of the vehicle 30 is generated, the generated content is stored in the server 20, and content corresponding to given information is played back in the internal space of the vehicle 30.

The content generating device 10 and the server 20 are connected to each other via a communication network 50 such that the content generating device 10 and the server 20 can communicate with each other. Further, the vehicle 30 and the server 20 are connected to each other via the communication network 50 such that the vehicle 30 and the server 20 can communicate with each other. The content generating device 10 and the vehicle 30 may or may not be connected with each other via the communication network 50. Note that, in the description of the present embodiment, the content generating device 10 and the vehicle 30 are not connected with each other via the communication network 50. For example, the communication network 50 is the Internet. However, this is not limitative. The communication network 50 may alternatively be any of other wireless communication modes.

The content generating device 10 is a device that generates content corresponding to a scene which changes as the vehicle 30 travels. In the description of the present embodiment, the content generating device 10 is a general-purpose computer. However, this is not limitative. The content generating device 10 may alternatively be a simulator constituted by dedicated hardware. The content generated by the content generating device 10 is transmitted to the server 20 via the communication network 50, and is stored in the server 20.

As an example of the content generated by the content generating device 10, the content corresponding to the scene which changes as the vehicle 30 travels has been explained. To be more specific, the content generated by the content generating device 10 is a virtual video linked to the scene which changes as the vehicle 30 travels. That is, the content generated by the content generating device 10 is content for providing mixed reality (MR). However, the content generated by the content generating device 10 is not limited to this. The content generated by the content generating device 10 may be content for providing “virtual reality” or content for providing “augmented reality”.

On the vehicle 30, various devices for playing back the content generated by the content generating device 10 are mounted. Further, the vehicle 30 has an application stored therein, the application being used to control playback of the content generated by the content generating device 10. This application corresponds to the later-described “content playback application 441”. This application requests the server 20 for content corresponding to given information, and plays back the content obtained from the server 20 with use of various devices.

In the description of the present embodiment, the vehicle 30 is a bus having an autonomous driving function. However, this is not limitative. The vehicle 30 may not have the autonomous driving function. Further, the vehicle 30 is not limited to the bus. The vehicle 30 may alternatively be a private car, a taxi, or any of other vehicles.

In the following description, the moving body applied to the content processing system 100 is the vehicle 30. However, the moving body is not limited to the vehicle 30. The moving body may alternatively be a ship, an aircraft, a space ship, or the like.

### (Example of Configuration of Hardware in Content Generating Device 10)

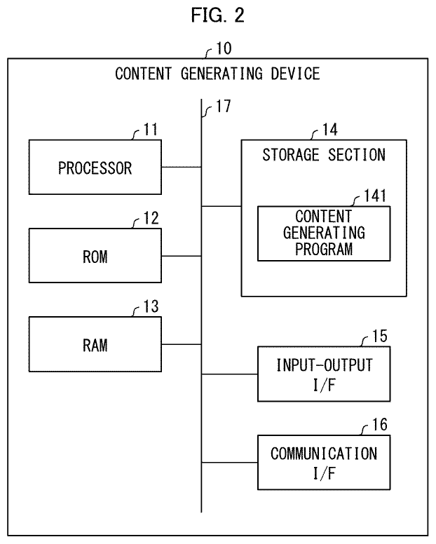

Next, the following will describe, with reference to FIG. 2, an example of a configuration of hardware in the content generating device 10. FIG. 2 is a block diagram illustrating an example of the configuration of the hardware in the content generating device 10.

As shown in FIG. 2, the content generating device 10 includes a processor 11, a read only memory (ROM) 12, a random access memory (RAM) 13, a storage section 14, an input-output interface (I/F) 15, and a communication interface (I/F) 16. These components are connected to each other via a bus 17 in a mutually communicable manner.

The processor 11 is an arithmetic unit for executing various programs, and is a central processing unit (CPU), for example. The processor 11 reads a program from the ROM 12 or the storage section 14, and executes various programs by using the RAM 13 as a work space. FIG. 2 illustrates a single processor 11. However, this is not limitative. Alternatively, a plurality of processors 11 may be provided.

The ROM 12 stores various programs and various data therein. As a working area, the RAM 13 temporarily stores a program or data therein. A computer-readable storage medium is not limited to the ROM 12 or the RAM 13. Examples of the computer-readable storage medium may encompass an erasable programmable ROM (EPROM) and an electrically erasable programmable ROM (EEPROM) (registered trademark).

The storage section 14 is constituted by a hard disk drive (HDD), a solid state drive (SSD), a flash memory, or the like. The storage section 14 stores various programs and various data therein. In the present embodiment, the storage section 14 stores a content generating program 141 therein.

The content generating program 141 is a program used to generate content for providing mixed reality. The content generating program 141 is a program for generating, with reference to scene information stored in the storage section 14 in advance, content corresponding to a scene which changes as the vehicle 30 travels (details thereof will be described later).

One example of the scene information stored in the storage section 14 in advance is image data obtained by capturing, by a camera, an image of a scene around the vehicle 30 while the vehicle 30 is traveling. The image data is stored in the storage section 14 as the scene information such that the image data is associated with position information obtained at the time of image-capturing. However, the scene information is not limited to this. For example, the scene information may be data obtained by referring to highly-precise three-dimensional map data which is a so-called high definition (HD) map.

The input-output I/F 15 is an interface used to connect input devices such as a mouse, a keyboard, and/or a touch panel with output devices such as a display, a microphone, and/or a speaker.

The communication I/F 16 is an interface which is implemented as hardware such as a network adapter, software for communication, or a combination thereof and which is used for communication with the server 20.

### (Example of Configuration of Hardware in Server 20)

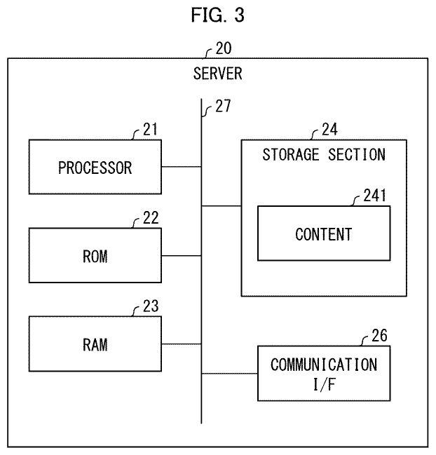

Next, the following will describe, with reference to FIG. 3, an example of a configuration of the hardware in the server 20. FIG. 3 is a block diagram illustrating an example of the configuration of the hardware in the server 20.

As shown in FIG. 3, the server 20 includes a processor 21, a ROM 22, a RAM 23, a storage section 24, and a communication I/F 26. These components are connected to each other via a bus 27 in a mutually communicable manner.

The processor 21, the ROM 22, the RAM 23, the storage section 24, and the communication I/F 26 are identical in configuration to the processor 11, the ROM 12, the RAM 13, the storage section 14, and the communication I/F 16 of the content generating device 10 described above. Therefore, explanations thereof will be omitted.

The storage section 24 stores therein content 241 transmitted from the content generating device 10.

### (Example of Configuration of Hardware Mounted on Vehicle 30)

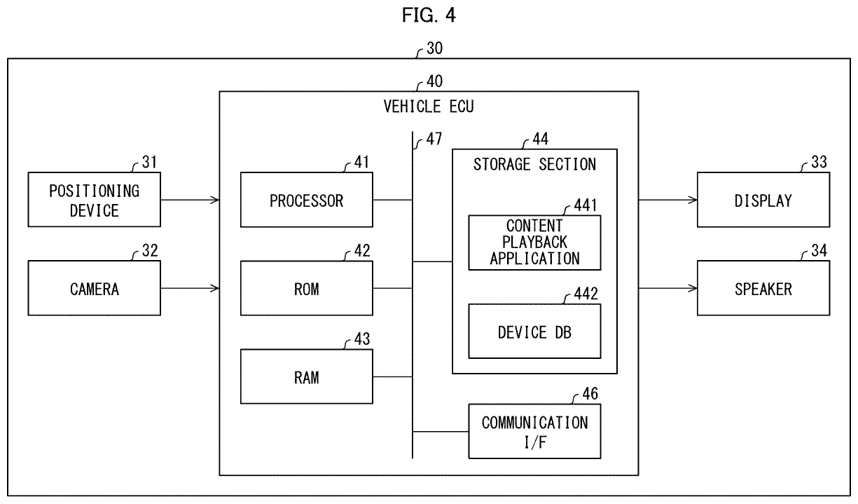

Next, the following will describe, with reference to FIG. 4, an example of a configuration of hardware mounted on the vehicle 30. FIG. 4 is a block diagram illustrating an example of the configuration of the hardware mounted on the vehicle 30.

As shown in FIG. 4, the vehicle 30 includes a positioning device 31, a camera 32, a vehicle electronic control unit (ECU) 40, a display 33, and a speaker 34.

The positioning device 31 measures a position of the vehicle 30. There is no particular limitation on the positioning device 31. The positioning device 31 may be, for example, a global navigation satellite system (GNSS) receiver. The positioning device 31 outputs, to the vehicle ECU 40, position information indicative of the measured position. Note that the method for measuring the position of the vehicle 30 is not limited to the method using the positioning device 31. Alternatively, the method for measuring the position of the vehicle 30 may be a method using odometry information based on an acceleration of the vehicle 30, for example. Therefore, it is not essential to mount the positioning device 31 on the vehicle 30.

The camera 32 includes an imaging element such as a charge-coupled device (CCD) or a complementary metal oxide semiconductor (CMOS). A position where the camera 32 is provided may be any position, provided that the position allows capturing of an image of a face of a passenger sitting on a seat (not illustrated in FIG. 4) of the vehicle 30. There is no particular limitation on the number of cameras 32 to be provided. The number of cameras 32 to be provided may be one or two or more. Note that the camera 32 may be a visible-light camera or an infrared camera having an infrared function.

The camera 32 captures an image of the passenger's face at a given cycle, and outputs the captured image data to the vehicle ECU 40. A mode of the camera 32 for capturing an image of the passenger's face may be either of a still image and a moving image. The image data is used to estimate a sight line of the passenger. This will be described in detail later.

The vehicle ECU 40 is a device that executes various kinds of control. As such an ECU, ECUs may sometimes be provided for respective mechanisms of the vehicle 30, such as an engine ECU for controlling an engine and/or a brake ECU for controlling a brake. The vehicle ECU 40 of the present embodiment may be a dedicated ECU for providing content to the passenger. Alternatively, the engine ECU, the brake ECU, or the like may function as the vehicle ECU 40.

The following will describe an example of a configuration of hardware in the vehicle ECU 40. The vehicle ECU 40 includes a processor 41, a ROM 42, a RAM 43, a storage section 44, and a communication I/F 46. These components are connected to each other via a bus 47 in a mutually communicable manner.

The processor 41, the ROM 42, the RAM 43, and the storage section 44 are identical in configuration to the processor 11, the ROM 12, the RAM 13, and the storage section 14 of the content generating device 10 described above. Therefore, explanations thereof will be omitted.

The storage section 44 stores therein the content playback application 441 and a device database 442.

As described above, the content playback application 441 is an application for controlling playback of the content generated by the content generating device 10. The content playback application 441 requests the server 20 for content corresponding to given information, and plays back, with use of various devices mounted on the vehicle 30, the content obtained from the server 20.

The device database 442 stores therein arrangement information of various devices mounted on the vehicle 30 and information relating to the types of the devices. The “arrangement information of devices” refers to information indicative of positions in the vehicle 30 in which positions the devices are arranged.

There is no particular limitation on the communication I/F 46. For example, the communication I/F 46 can be an interface for an in-vehicle network which is in compliance with the controller area network (CAN) standard. Further, the communication I/F 46 also includes an interface used for communication with the server 20.

The display 33 is one of the various devices mounted on the vehicle 30, and functions as a display device that displays content. There is no particular limitation on the number of displays 33 mounted on the vehicle 30. The number of displays 33 mounted on the vehicle 30 may be one or two or more. In the description of the present embodiment, the number of displays 33 mounted on the vehicle 30 is two or more. In an example discussed here, each of the displays 33 is a display which is a so-called “smart window” capable of switching its state between transparent and opaque. For example, the “smart window” becomes opaque when non-energized, and “smart window” becomes transparent when energized. That is, by controlling an electric current, each of the displays 33 in accordance with the present embodiment can function as either of a “transparent window” and a “display device for displaying content”. In the description of the present embodiment, the “windows” of the vehicle 30 are all made of the display 33. However, this is not limitative. Alternatively, some of the “windows” of the vehicle 30 may be made of the display 33.

The speaker 34 is one of the various devices mounted on the vehicle 30, and functions as an audio output device that outputs audio of the content. There is no particular limitation on the number of speakers 34 mounted on the vehicle 30. The number of speakers 34 mounted on the vehicle 30 may be one or two or more. In the description of the present embodiment, the number of speakers 34 mounted on the vehicle 30 is two or more.

### (Function of Processor 11 of Content Generating Device 10)

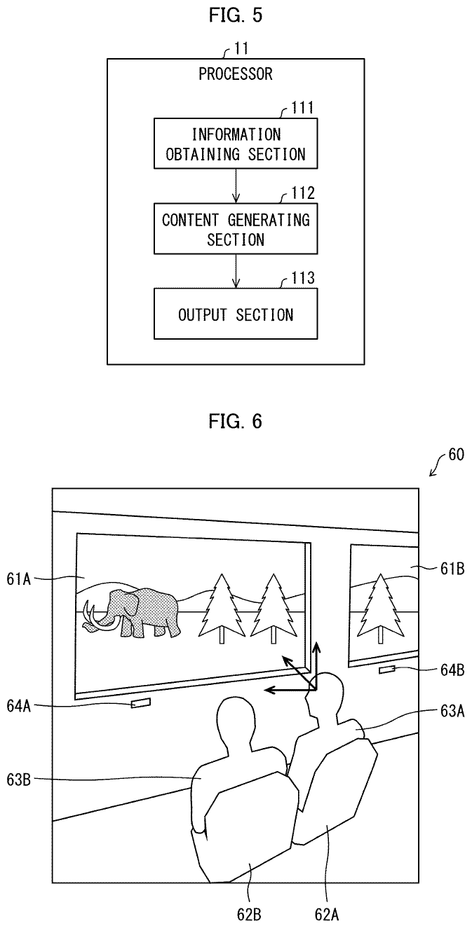

Next, the following will describe, with reference to FIG. 5, an example of a function of the processor 11 of the content generating device 10. FIG. 5 is a functional block diagram of the processor 11 of the content generating device 10. As shown in FIG. 5, in the content generating device 10 of the present embodiment, the processor 11 executes the content generating program 141 so as to realize functions of an information obtaining section 111, a content generating section 112, and an output section 113.

The information obtaining section 111 obtains information required to generate content. In the present embodiment, examples of the information required to generate the content pieces of include three information: arrangement information (A1) of various devices mounted on the vehicle 30; sight-line information (A2) of the passenger; and traveling information (A3) of the vehicle 30. One example of the “arrangement information of the various devices mounted on the vehicle 30” herein is the arrangement information of the displays 33 and arrangement information of the speakers 34. One example of the “traveling information of the vehicle 30” is position information of the vehicle 30 which is traveling and scene information associated with the position information. In order to generate the content, it is not essential to use the three pieces of information (A1) to (A3). For example, the content may be generated by using the two pieces of information (A1) and (A3).

One example of a method for obtaining the three pieces of information (A1) to (A3) can be a method using an input module prepared by the content generating program 141. The “input module” herein is a module allowing a person who generates content (hereinafter, simply referred to as a “content generating person”) to input an initial condition and/or a parameter necessary to generate the content. In a case where the input module is configured such that, for example, items for inputting the “arrangement information of the displays 33”, the “arrangement information of the speakers 34”, the “sight-line information of the passenger”, the “position information of the vehicle 30”, and/or the like is/are prepared, the content generating person may input these pieces of information to the input module. The content generating program 141 may obtain the “scene information associated with the position information of the vehicle 30” by referring to the storage section 14 on the basis of the “position information of the vehicle 30” having been input to the input module.

Here, the following will describe, with reference to FIG. 6, an example of operation of the content generating program 141 carried out when the three pieces of information are input by the content generating person. FIG. 6 shows a simulation screen showing simulation of a part of the internal space of the vehicle 30, the simulation screen being given when the three pieces of information are input by the content generating person. As shown in FIG. 6, a simulation screen 60 indicates virtual displays 61A and 61B, virtual seats 62A and 62B, virtual passengers 63A and 63B sitting on the virtual seats 62A and 62B, and virtual speakers 64A and 64B.

The content generating program 141 accepts an input from the content generating person, and generates the simulation screen 60 on the basis of the input.

Each of the virtual displays 61A and 61B gives virtual presentation of a corresponding one of the plurality of displays 33 mounted on the actual vehicle 30. Each of the virtual seats 62A and 62B gives virtual presentation of a corresponding one of the plurality of seats mounted on the actual vehicle 30. Each of the virtual passengers 63A and 63B gives virtual presentation of a corresponding one of passengers riding on the actual vehicle 30. Each of the virtual speakers 64A and 64B gives virtual presentation of a corresponding one of the plurality of speakers 34 mounted on the actual vehicle 30. The arrows in FIG. 6 indicate directions of sight lines of the virtual passenger 63A. Here, each of the directions of the sight lines of the virtual passenger 63A is indicated in a three-dimensional coordinate system. However, this is not limitative. Assume that the content generating person has also input the arrangement information of the actual seats. The arrangement information of the seats may be included in the “arrangement information of the various devices mounted on the vehicle 30” described as (A1) above.

After generating the simulation screen 60 with use of the content generating program 141, the content generating person generates content corresponding to a scene which changes as the vehicle 30 travels. There is no particular limitation on the method for generating the content. For example, the method for generating the content can be a method using a generation module prepared by the content generating program 141. The “generation module” herein is a module including a plurality of models for generating content corresponding to the scene which changes as the vehicle 30 travels. The content generating person can select, from among the plurality of models, a model which is to be desired to be provided to the passenger. Examples of the plurality of models include: a model in which a mammoth appears in accordance with a scene which changes as the vehicle 30 travels; and a model in which a firework is shot up in accordance with a scene which changes as the vehicle 30 travels. Here, assume that the content generating person selects the model in which the mammoth appears. In this case, in accordance with the selection made by the content generating person, the content generating program 141 generates content in which a mammoth appears, as shown in FIG. 6.

The mammoth is a three-dimensional object arranged in a virtual space corresponding to a scene which changes as the vehicle 30 moves. The “virtual space” herein means a three-dimensional space model constituted by a three-dimensional map of a given range and various three-dimensional objects arranged on the three-dimensional map. Note that the virtual space may be either of (i) a space model which faithfully copies a real space in which the vehicle 30 is actually traveling and (ii) a space model which simulates a space in which the vehicle 30 cannot actually travel, such as the bottom of the sea or a space in the air. Further, the virtual space may include a combination of (i) a map and an object(s) each simulating an object or a phenomenon existing in a real space and (ii) a map and an object(s) each simulating an object or a phenomenon not existing in a real space.

The operation carried out by the content generating program 141 with use of the generation module corresponds to the “content generating section 112”.

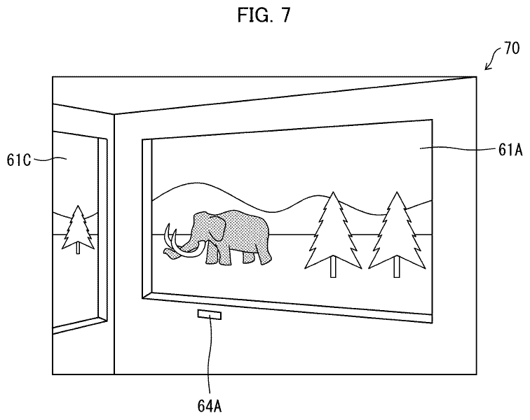

Use of the sight-line information of the virtual passenger 63A allows the content generating person to generate content while confirming a scene seen by a passenger who actually rides on the vehicle 30. For example, a scene seen by the virtual passenger 63A shown in FIG. 6 is a scene illustrated in FIG. 7. As in a simulation screen 70 shown in FIG. 7, the sight line of the virtual passenger 63A can catch the virtual displays 61A and 61C, but cannot catch the virtual display 61B. In this manner, the content generating person can generate content as if he/she generated the content while confirming the sight line of the virtual passenger 63A who rides on the vehicle 30. This makes it possible to provide content not causing uncomfortable feeling even for a passenger actually riding on the vehicle. Note that the virtual display 61C, which is disposed on the left of the virtual display 61A, is not shown in FIG. 6.

By generating the content while carrying out such simulation, it is possible to generate content corresponding to a scene which changes as the vehicle 30 travels, even without causing the vehicle 30 to travel actually. Further, even without causing the vehicle 30 to travel actually, it is also possible to confirm, on a simulator, how the content is seen by the passenger when the vehicle 30 is caused to travel. As discussed above, according to the present embodiment, it is possible to generate and confirm content even without causing the vehicle 30 to travel actually. This makes it possible to reduce the cost for generating the content.

The output section 113 transmits, to the server 20, the content generated by the content generating section 112. The server 20 stores therein the content transmitted from the content generating device 10.

### (Function of Processor 11 of Vehicle 30)

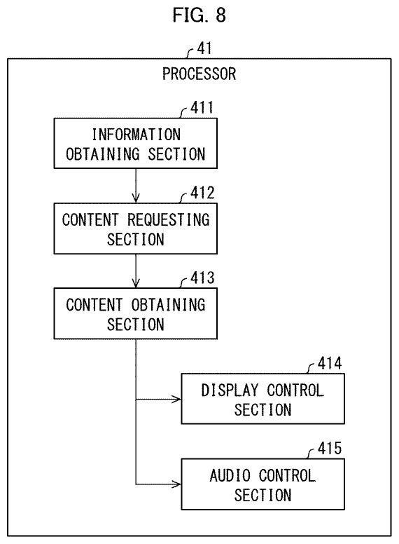

Next, the following will describe, with reference to FIG. 8, an example of the function of the processor 41 of the vehicle 30. FIG. 8 is a functional block diagram of the processor 41 of the vehicle 30. As shown in FIG. 8, in the vehicle ECU 40 of the present embodiment, the processor 41 executes the content playback application 441 so as to realize functions of an information obtaining section 411, a content requesting section 412, a content obtaining section 413, a display control section 414, and an audio control section 415.

The information obtaining section 411 obtains information for requesting the server 20 for content to be played back. In the present embodiment, examples of the information necessary to request the content to be played back include three pieces of information: arrangement information (B1) of various devices mounted on the vehicle 30; sight-line information (B2) of the passenger; and traveling information (B3) of the vehicle 30. One example of the “arrangement information of the various devices mounted on the vehicle 30” herein is the arrangement information of the displays 33 and the arrangement information of the speakers 34. One example of the “traveling information of the vehicle 30” is position information of the vehicle 30 which is traveling. That is, in the present embodiment, the above-described three pieces of information (A1) to (A3) respectively correspond to the three pieces of information (B1) to (B3). In order to request the content to be played back, it is not essential to use the three pieces of information (B1) to (B3). For example, the two pieces of information (B1) and (B3) may be used to request the content.

The following will describe an example of a method for obtaining the three pieces of information (B1) to (B3). First, the content playback application 441 can obtain the “arrangement information of the displays 33” and the “arrangement information of the speakers 34” by referring to the device database 442 stored in the storage section 44.

Next, the content playback application 441 can obtain the “sight-line information of the passenger” by analyzing image data from the camera 32 by a known method.

Next, the content playback application 441 can obtain the “position information of the vehicle 30” from the positioning device 31.

The content playback application 441 requests the server 20 for content corresponding to these three pieces of information. This function corresponds to the content requesting section 412.

Next, the content playback application 441 obtains the content transmitted from the server 20. This function corresponds to the content obtaining section 413. Then, the content playback application 441 plays back, with use of the displays 33 and the speakers 34, the content obtained from the server 20. This function corresponds to the display control section 414 and the audio control section 415.

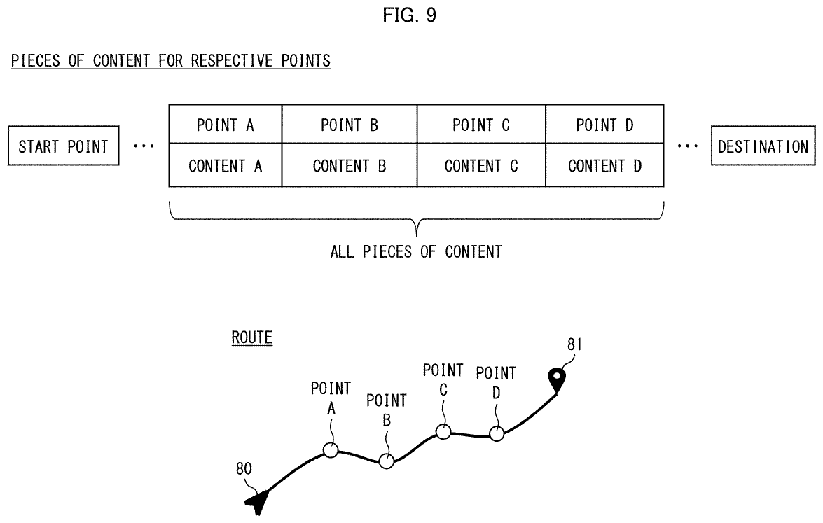

Here, the following will describe, with reference to FIG. 9, an example of operation of the content playback application 441. FIG. 9 is a view illustrating a relation between (i) points through which the vehicle 30 passes when the vehicle 30 travels from a start point 80 to a destination 81 and (ii) pieces of content for the respective points.

The content playback application 441 obtains, at the point A, the above-described pieces of information (B1) to (B3), that is, arrangement information of the displays 33 at the point A, arrangement information of the speakers at the point A, sight-line information of the passenger at the point A, and position information of the vehicle 30 at the point A. The content playback application 441 requests the server 20 for content corresponding to the obtained information.

The server 20 identifies content corresponding to the information obtained from the content playback application 441, and transmits the identified content to the content playback application 441. Here, the content corresponding to the point A will be referred to as “content A”. That is, the server 20 transmits the content A to the content playback application 441.

The content playback application 441 plays back, with use of the displays 33 and the speakers 34, the content A obtained from the server 20.

In the example shown in FIG. 9, divided pieces of content are generated for respective points. This is because, in simulation for generating content, a limitation on a traveling range which can be simulated is assumed to be present. If the limitation on the traveling range is eliminated, a capacity of the content increases as a traveling distance would increase. This may cause an increase in the burden of managing the content in the server 20 and/or an increase in time and load taken to download the content from the server 20. In order to deal with this, according to the present embodiment, pieces of content are generated for respective points within a traveling range which can be simulated, as shown in FIG. 9. Thanks to the pieces of content divided for the respective points in this manner, (i) the burden of managing the content in the server 20 and (ii) the time and load taken to download the content from the server 20 are reduced. However, it is not essential that the pieces of content are divided for the respective points. There is no particular limitation on the traveling range which can be simulated. For example, the traveling range which can be simulated may be 500 m.

When the vehicle 30 arrives at the point B after passing through the point A, the content playback application 441 obtains, at the point B, the above- described pieces of information (B1) to (B3), that is, arrangement information of the displays 33 at the point B, arrangement information of the speakers at the point B, sight-line information of the passenger at the point B, and position information of the vehicle 30 at the point B.

Here, in a case where the various devices (in the configuration shown in FIG. 9, the displays 33 and the speakers 34) mounted on the vehicle 30 are fixed in an unmovable manner, once the content playback application 441 obtains arrangement information of the devices, the content playback application 441 may not obtain arrangement information of the devices at the next and subsequent points and may use again the arrangement information of the devices having been already obtained. That is to say, in a case where the displays 33 and the speakers 34 are fixed in an unmovable manner, the content playback application 441 may use, at the point B again, the arrangement information of the displays 33 and the speakers 34 obtained at the point A. Of course, in a case where the displays 33 and the speakers 34 are movable, the content playback application 441 may obtain arrangement information of the displays 33 and the speakers 34 every time the vehicle arrives at each point.

In a similar manner to the operation carried out at the point A, the content playback application 441 requests the server 20 for content corresponding to the information obtained at the point B.

The server 20 identifies content corresponding to the information obtained from the content playback application 441, and transmits the identified content to the content playback application 441. Here, the content corresponding to the point B will be referred to as “content B”. That is, the server 20 transmits the content B to the content playback application 441.

The content playback application 441 plays back, with use of the displays 33 and the speakers 34, the content B obtained from the server 20.

The operation of content playback the application 441 carried out at each of the points C and D is identical to the operation carried out at each of the points A and B. Therefore, descriptions on the operation of the content playback application 441 carried out at each of the points C and D will be omitted.

The content may include an event. The “event” herein refers to an event that can be sensed by the passenger with five senses. Examples of such an event include odor, wind, vibration, sound, and light. The above-described firework is one kind of event. In a case where the content is a video of the firework, the passenger can enjoy the content with the sense of sight. Further, in a case where whistling sound and/or blast sound is output from the speakers 34 in accordance with the video of the firework, the passenger can enjoy the content also with the sense of hearing. Such an event can be set for each of the points, that is, for each of the pieces of content.

There is no particular limitation on the data contained in the content. For example, the data contained in the content may include: mp4 data which is pieces of video data at the respective points; wav data which is audio data; and json data which is video control information.

In requesting the server 20 for the content, the content playback application 441 may transmit a vehicle ID for identifying the vehicle 30. The use of the vehicle ID enables the server 20 to manage information indicating relations between vehicles and pieces of content having been transmitted to the respective vehicles.

For convenience of description, in FIG. 9, a section from the start point 80 to the point A, a section from the point A to the point B, a section from the point B to the point C, a section from the point C to the point D, and a section from the point D to the destination 81 are each depicted as a section not having content. However, this is not limitative. Alternatively, pieces of content may be filled in all the sections from the start point 80 to the destination 81 without skipping any section.

### (Example of Content Process)

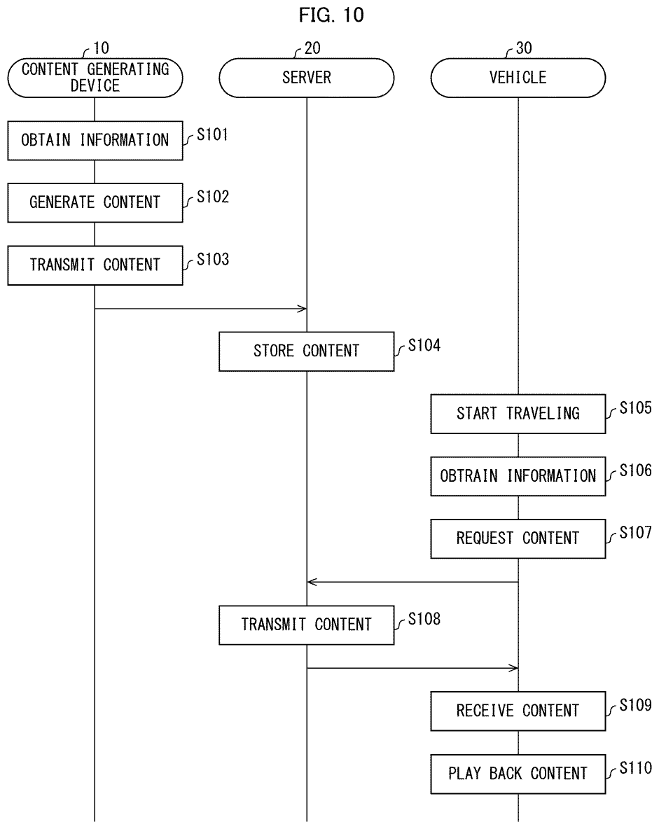

Next, the following will describe, with reference to the sequence chart shown in FIG. 10, an example of content processing carried out between the content generating device 10, the server 20, and the vehicle 30.

In step S101, the processor 11 of the content generating device 10 obtains three pieces of information, that is, the arrangement information (A1) of the various devices mounted on the vehicle 30, the sight-line information (A2) of the passenger, and the traveling information (A3) of the vehicle 30.

The process advances to step S102. Then, the processor 11 of the content generating device 10 generates the simulation screen 60 (see FIG. 6) on the basis of the three pieces of information (A1) to (A3) obtained in the process in step S101. In accordance with a manipulation carried out by the content generating person with respect to the simulation screen 60, the processor 11 of the content generating device 10 generates content corresponding to a scene which changes as the vehicle 30 travels.

The process advances to step S103. The processor 11 of the content generating device 10 transmits, to the server 20, the content generated in the process in step S102. As explained with reference to FIG. 9, in a case where pieces of content are generated for the respective points, the pieces of content generated for the respective points are transmitted to the server 20.

In step S104, the server 20 stores therein the content transmitted from the content generating device 10.

In step S105, the vehicle 30 travels toward the destination 81 (see FIG. 9) which has been set.

The process advances to step S106. Then, at the point A which is on the way to the destination 81, the processor 41 of the vehicle 30 obtains three pieces of information, that is, the arrangement information (B1) of the various devices mounted on the vehicle 30, the sight-line information (B2) of the passenger, and the traveling information (B3) of the vehicle 30. The three pieces of information (A1) to (A3) in step S101 respectively correspond to the three pieces of information (B1) to (B3) in step S106.

The process advances to step S107. Then, the processor 41 of the vehicle 30 requests the server 20 for content corresponding to the pieces of information obtained in the process in step S106.

In step S108, the server 20 identifies the content corresponding to the pieces of information obtained from the vehicle 30, and transmits the identified content to the vehicle 30. For example, when the vehicle 30 is traveling at the point A, the server 20 transmits the content A to the vehicle 30.

In step S109, the processor 41 of the vehicle 30 obtains the content (e.g., the content A) from the server 20.

The process advances to step S110. The processor 41 of the vehicle 30 plays back, with use of the displays 33 and the speakers 34, the content (e.g., the content A) obtained in the process in step S109.

Note that the flow of the process shown in the sequence chart in FIG. 10 is one example. In the flow of the process shown in the sequence chart in FIG. 10, some of the steps may be removed, an additional step may be added, and/or the order of some of the processes may be changed, within a range being not deviated from the gist.

For example, in step S106, the processor 41 of the vehicle 30 may start obtaining the three pieces of information (B1) to (B3) in response to a given trigger. The given trigger is, for example, a signal transmitted from a smartphone of the passenger. When the passenger wishes to experience content, the passenger can experience the content by manipulating a dedicated application installed in his/her smartphone. The processor 41 of the vehicle 30 may start obtaining the three pieces of information in response to reception of a signal given when the dedicated application manipulated.

### (Variations of First Embodiment)

Next, the following will describe variations of the first embodiment.

In the description above, the content is generated with use of the three pieces of information (A1) to (A3). However, this is not limitative. The content may be generated with use of, in addition to these three pieces of information, another information. For example, the content generating program 141 may generate the content with use of, in addition to these three pieces of information, information relating to a type of the device.

The “type of the device” herein is the one that can be discriminated by, e.g., the performance, shape, characteristics, and/or the like of the device. For example, the displays 33 can be classified into two kinds, that is, a “display capable of switching its state between transparent and opaque” and a “general-purpose display not capable of switching its state between transparent and opaque”. The content to be generated may be changed depending on which of the two kinds the displays mounted on the vehicle 30 are. Note that the classification into the two kinds is merely one example. Needless to say, there are many kinds of displays, such as displays each having a curved surface and foldable displays.

For another example, the speakers 34 can be classified into three kinds, that is, a “monaural speaker”, a “stereo speaker”, and a “multichannel speaker”. The content to be generated may be changed depending on which of the three kinds of speakers the speakers mounted on the vehicle 30 are. Note that the classification into the three kinds is merely one example. Needless to say, there are many kinds of speakers, such as speakers excellent in low frequencies, speakers excellent in high frequencies, and speakers for high-resolution audio.

By generating the content with use of, in addition to the three pieces of information (A1) to (A3), the information relating to the type of the device in this manner, it is possible to generate content which utilizes the performance of the device to a fullest extent. The type of the device may be input, by the content generating person, into the content generating program 141.

Similarly, also in requesting the server 20 for the content, the content playback application 441 may additionally use the information relating to the type of the device. The information relating to the type of the device may be stored in the storage section 44 in advance. This allows the content playback application 441 to obtain the information relating the type of the device at an arbitrary timing.

### (Effects)

As discussed above, the content processing system 100 in accordance with the first embodiment provides the following effects.

The content processing system 100 includes the content generating device 10, the storage device, and the content playback device which is to be mounted on the moving body. One example of the “storage device” herein is the server 20. One example of the “content playback device” is the vehicle ECU 40.

The content generating device 10 obtains the information relating to the internal space of the moving body, and obtains the information relating to traveling of the moving body. One example of the “information relating to the internal space of the moving body” herein is the above-described information (A1). One example of the “information relating to traveling of the moving body” herein is the above-described information (A3).

The content generating device 10 generates, on the basis of the information relating to the internal space of the moving body and the information relating to traveling of the moving body, content corresponding to a scene which changes as the moving body travels, and stores the generated content in the storage device.

The content playback obtains the information relating to the internal space of the moving body, and obtains the information relating to traveling of the moving body. One example of the “information relating to the internal space of the moving body” herein is the above-described information (B1). One example of the “information relating to traveling of the moving body” herein is the above-described information (B3).

The content playback device obtains, from the storage device, the content corresponding to the information relating to the internal space of the moving body and the information relating to traveling of the moving body, and plays back the obtained content.

With the above configuration, even without causing the moving body to travel actually, it is possible to generate the content corresponding to the scene which changes as the moving body travels. Further, even without causing the moving body to travel actually, it is also possible to confirm, on a simulator, how the content is seen by the passenger when the moving body is caused to travel. With the conventional method described above, it is necessary to confirm how the content is seen from the sight line of the passenger while causing the moving body to travel actually. This is a cause for the increase in the cost for generating the content. In contrast to this, with the present embodiment, it is possible to generate and confirm content, even without causing the moving body to travel actually. This makes it possible to reduce the cost for generating the content.

Since the content is a virtual video of, e.g., a mammoth or a firework, the passenger can enjoy, with the sense of sight, the virtual video linked to a scene which changes as the moving body travels. Further, in a case where whistling sound and/or blast sound is output from the speakers 34 in accordance with the video of the firework, the passenger can enjoy the content also with the sense of hearing. As discussed above, with the present embodiment, it is possible to provide content which stimulates the passenger with five senses. Thus, the passenger can attain a new experience.

When viewed from the content generating device 10 side, the storage device is an external storage device and the moving body is an external moving body. Meanwhile, when viewed from the moving body side, the storage device is an external storage device.

Further, the content generating device 10 may further obtain information relating to the passenger sitting in the internal space of the moving body. One example of the “information relating to the passenger sitting in the internal space of the moving body” herein is the above-described information (A2). Examples of the “passenger” include a driver who drives the moving body and a passenger who rides on the moving body.

The content generating device 10 generates, on the basis of the information relating to the internal space of the moving body, the information relating to the passenger, and the information relating to traveling of the moving body, content corresponding to a scene which changes as the moving body travels, and stores the generated content in the storage device.

Further, the content playback device may further obtain the information relating to the passenger sitting in the internal space of the moving body. One example of the “information relating to the passenger sitting in the internal space of the moving body” herein is the above-described information (B2).

The content playback device may obtain, from the storage device, content corresponding to the information relating to the internal space of the moving body, the information relating to the passenger, and the information relating to traveling of the moving body, and may play back the obtained content.

With the above configuration, it is possible to obtain similar effects to the above-described effects.

Further, the information relating to the internal space of the moving body may be arrangement information of at least one device arranged in the internal space of the moving body. The content generating device 10 may further obtain information relating to the type of the at least one device. The content generating device 10 may generate content on the basis of the arrangement information of the at least one device, the information relating to the passenger, the information relating to traveling of the moving body, and the information relating to the type of the at least one device.

Further, the content playback device may obtain the information relating to the type of the at least one device. The content playback device may obtain, from the storage device, content corresponding to the arrangement information of the at least one device, the information relating to the passenger, the information relating to traveling of the moving body, and the information relating to the type of the at least one device.

The above configuration generates the content by additionally using the information relating to the type of the at least one device in this manner. This makes it possible to generate content which utilizes the performance of the device to a fullest extent.

Further, the content generating device 10 may generate pieces of content for respective given ranges, and may store the pieces of content for the respective given ranges in the storage device.

The above configuration reduces (i) the burden of managing the content in the storage device and/or (ii) the time and load taken to download the content from the storage device.

### Second Embodiment

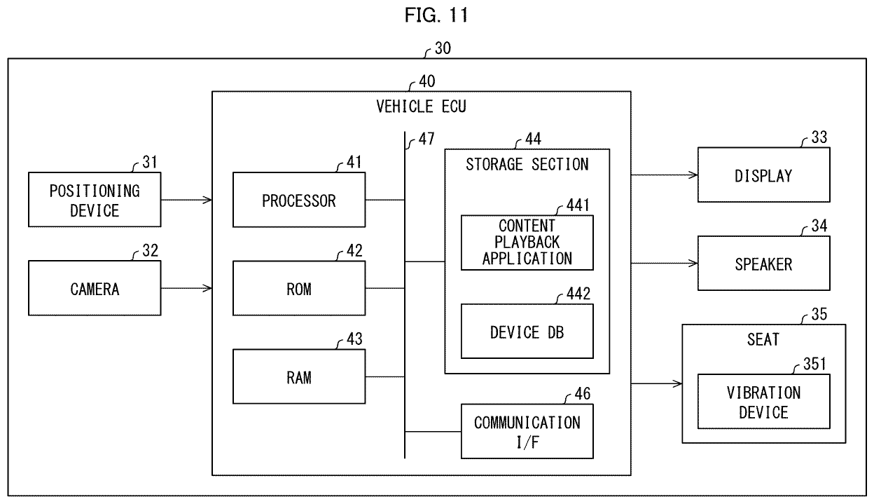

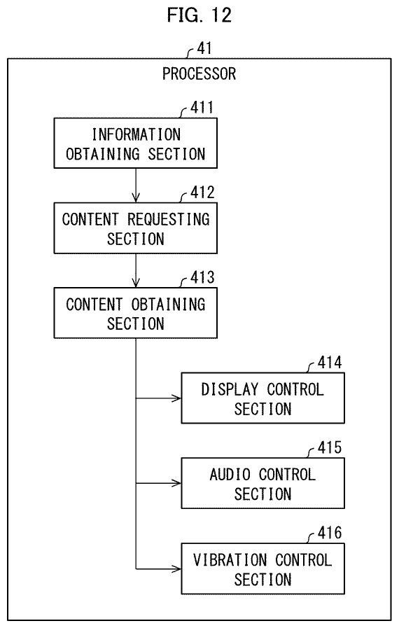

Next, the following will describe a second embodiment of the present disclosure with reference to FIGS. 11 and 12. For convenience of description, a member having a function identical to that of a member discussed in the first embodiment is given an identical reference sign, and a description thereof is omitted.

FIG. 11 is a block diagram illustrating an example of a configuration of hardware mounted on a vehicle 30 in accordance with the second embodiment. As shown in FIG. 11, a seat 35 mounted on the vehicle 30 may be provided with a vibration device 351.

With the configuration in which the seat 35 is provided with the vibration device 351, it is possible to provide a new experience to a passenger by vibrating the seat 35 in accordance with an event. For example, in a case where the event is a firework, it is possible to vibrate the seat 35 in accordance with a timing of bursting of the firework, thereby allowing the passenger to simulatively experience vibration of the air occurring at the time of bursting of the firework. Thus, the passenger can attain a new experience. As described above, the content may include not only a moving image and audio but also vibration.

In the case where the seat 35 is provided with the vibration device 351, a processor 41 of the vehicle 30 can function as a vibration control section 416, as shown in FIG. 12. In other words, the content playback application 441 functions as an application capable of controlling vibration of the seat 35.

Further, a content generating program 141 may generate the content by additionally using information relating to a type of the vibration device 351. One example of the type of the vibration device 351 is an amplitude and/or a cycle of the vibration. By generating the content also in consideration of the amplitude and/or the cycle of the vibration, it is possible to generate the content which utilizes the performance of the vibration device 351 to a fullest extent.

### Third Embodiment

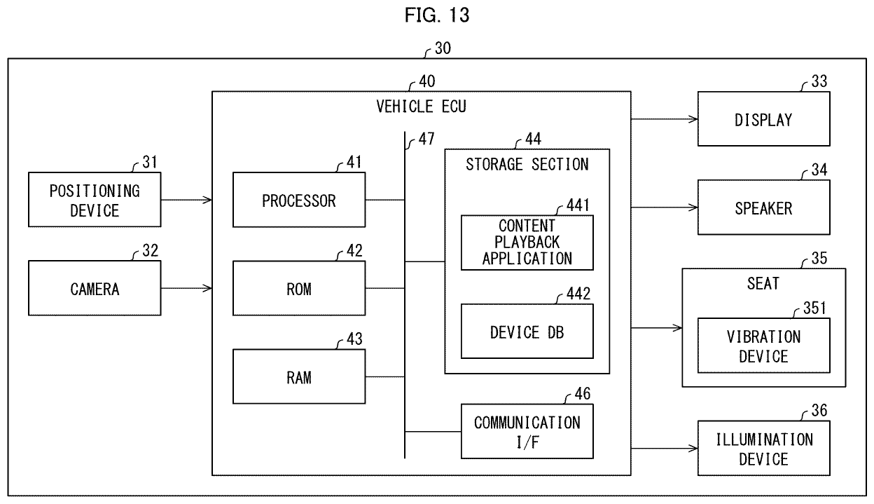

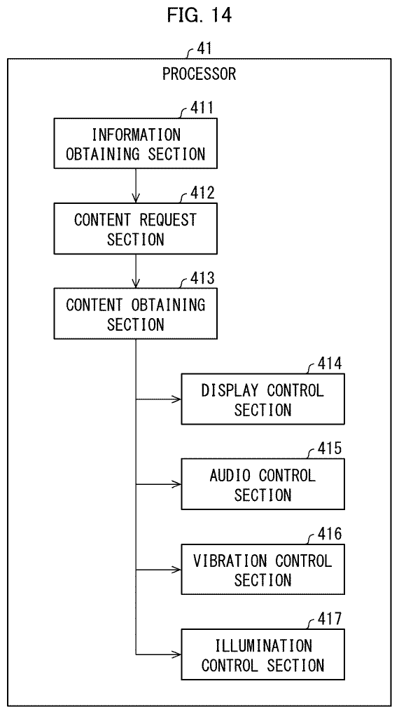

Next, the following will describe a third embodiment of the present disclosure with reference to FIGS. 13 and 14. For convenience of description, a member having a function identical to that of a member discussed in the second embodiment is given an identical reference sign, and a description thereof is omitted.

FIG. 13 is a block diagram illustrating an example of a configuration of hardware mounted on a vehicle 30 in accordance with the third embodiment. As shown in FIG. 13, the vehicle 30 may be provided with an illumination device 36.

With the configuration in which the vehicle 30 is provided with the illumination device 36, it is possible to provide a new experience to a passenger by controlling the illumination device 36 in accordance with an event. For example, in a case where the event is a firework, it is possible to brighten up an interior of the vehicle at a timing of bursting of the firework and to darken the interior of the vehicle at timings other than the timing of bursting of the firework, thereby making it possible to enhance the presentation effect of the firework. Thus, it is possible to provide the passenger with a space giving realistic feeling. As described above, the content may be the one including not only a moving image, audio, and vibration but also illumination.

In a case where the vehicle 30 is provided with the illumination device 36, a processor 41 of the vehicle 30 can function as an illumination control section 417, as shown in FIG. 14. In other words, a content playback application 441 functions as an application capable of controlling the illumination device 36.

Further, the content generating program 141

may generate the content by additionally using information relating to the type of the illumination device 36. The type of the illumination device 36 can be classified according to, e.g., a dimming function.

Specifically, the illumination device can be, for example, an illumination device capable of adjusting brightness at several levels or an illumination device capable of adjusting the color of light. By generating the content also in consideration of the type of the illumination device 36, it is possible to generate the content which utilizes the performance of the illumination device 36 to a fullest extent.

In switching a state of a display 33 between transparent and opaque, dimming control using the illumination device 36 can be carried out. This enables smooth switching.

### Fourth Embodiment

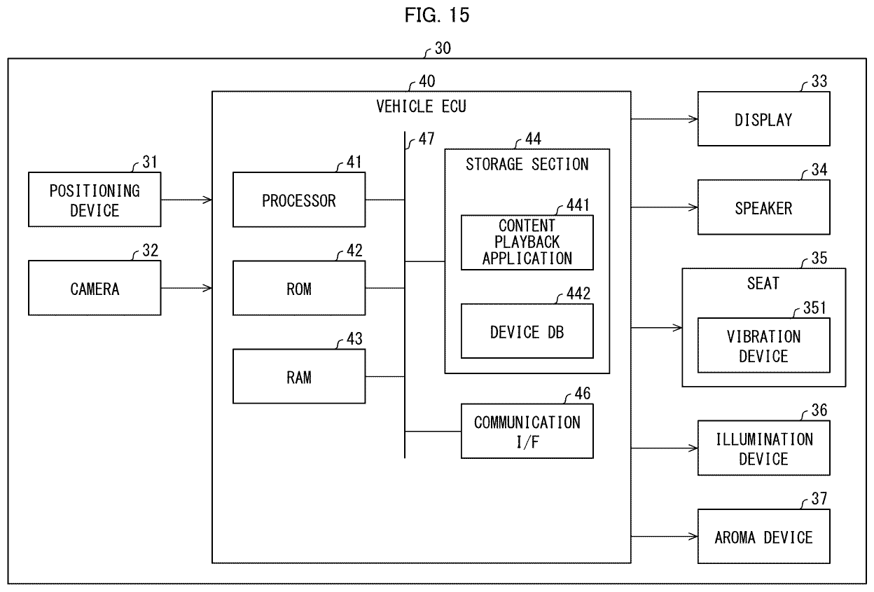

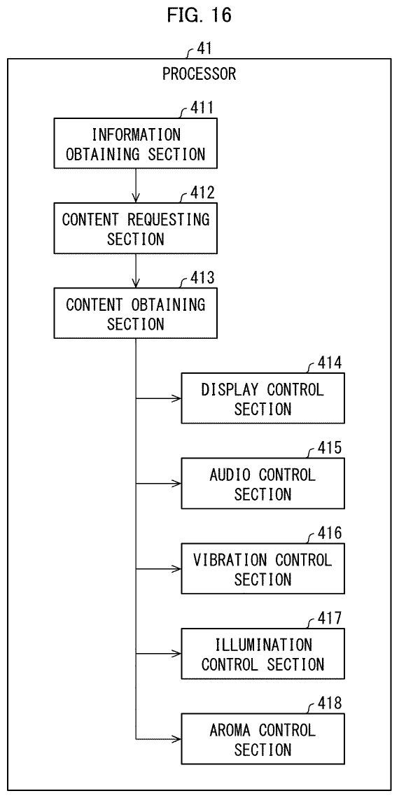

Next, the following will describe a fourth embodiment of the present disclosure with reference to FIGS. 15 and 16. For convenience of description, a member having a function identical to that of a member discussed in the third embodiment is given an identical reference sign, and a description thereof is omitted.

FIG. 15 is a block diagram illustrating an example of a configuration of hardware mounted on a vehicle 30 in accordance with the fourth embodiment. As shown in FIG. 15, the vehicle 30 may be provided with an aroma device 37.

With the configuration in which the vehicle 30 is provided with the aroma device 37, it is possible to provide a new experience to a passenger by controlling the aroma device 37 in accordance with an event. For example, in a case where the event is a firework, aroma of lavender may be released into an interior of the vehicle in accordance with a timing of bursting of the firework. Consequently, a passenger can be relaxed by the aroma of lavender while enjoying the firework. Thus, the passenger can attain a new experience. As described above, the content may be the one including not only a moving image, audio, vibration, and illumination but also aroma.

In a case where the vehicle 30 is provided with the aroma device 37, a processor 41 of the vehicle 30 may function as an aroma control section 418, as shown in FIG. 16. In other words, a content playback application 441 functions as an application capable of controlling the aroma device 37.

Further, the content generating program 141 may generate the content by additionally using the information relating to the type of the aroma device 37, i.e., the information relating to the type of the aroma. Examples of the type of the aroma include not only the above-described lavender but also vanilla, rose, citrus, and jasmine. By generating the content also in consideration of the type of the aroma, it is possible to generate the content which utilizes the performance of the aroma device 37 to a fullest extent.

### Other Embodiments

A combination of the moving image, audio, vibration, illumination, and aroma included in the content may be arbitrarily determined.

### [Software Implementation Example]

The functions of the content generating device 10 and the content playback device can be realized by a program causing a computer to function as the content generating device 10 and the content playback device, the program causing the computer to function as each of the control blocks of the content generating device 10 and the content playback device.

In this case, the content generating device 10 and the content playback device include, as hardware for executing the program, a computer including at least one device (e.g., a processor) and at least one storage section (e.g., a memory). Each function described in the foregoing embodiments can be realized by the computer executing the program.

The program may be stored in one or more non-transitory computer-readable storage media. This storage medium may or may not be provided in the content generating device 10 and the content playback device. In the latter case, the program can be supplied to the content generating device 10 and the content playback device via any transmission medium such as a wired transmission medium or a wireless transmission medium.

Further, some or all of functions of the control blocks can be realized by a logic circuit. For example, the present disclosure encompasses, in its scope, an integrated circuit in which a logic circuit that functions as each of the control blocks is formed. As another alternative, for example, it is possible to realize the functions of the control blocks by a quantum computer.

Further, each of the processes which are described in the foregoing embodiments may be executed by artificial intelligence (AI). In this case, the AI may be operated by the content generating device 10 and the content playback device. Alternatively, the AI may be operated by another device (e.g., an edge computer, a cloud server, or the like).

The present disclosure is not limited to the foregoing embodiments, but can be altered within the scope of the claims. The present disclosure also encompasses, in its technical scope, any embodiment derived by combining technical means disclosed in differing embodiments.

### REFERENCE SIGNS LIST

100: content processing system
10: content generating device
20: server
30: vehicle
40: vehicle ECU
11, 21, 41: processor
14, 24, 44: storage section
441: content playback application

1. A content processing system comprising:
a content generating device;
a storage device; and
a content playback device which is to be mounted on a moving body,
the content generating device being configured to:
obtain information relating to an internal space of the moving body;
obtain information relating to traveling of the moving body;
generate, on a basis of the information relating to the internal space and the information relating to traveling, content corresponding to a scene which changes as the moving body travels; and
store the generated content in the storage device, and
the content playback device being configured to:
obtain the information relating to the internal space of the moving body;
obtain the information relating to traveling of the moving body;
obtain, from the storage device, the content corresponding to the information relating to the internal space and the information relating to traveling; and
play back the obtained content.

2. The content processing system according to claim 1, wherein
the content generating device is further configured to:
obtain information relating to a passenger sitting in the internal space of the moving body; and
generate, on a basis of the information relating to the internal space, the information relating to the passenger, and the information: relating to traveling, content corresponding to a scene which changes as the moving body travels, and
the content playback device is further configured to:
obtain the information relating to the passenger sitting in the internal space of the moving body;
obtain, from the storage device, the content corresponding to the information relating to the internal space, the information relating to the passenger, and the information relating to traveling; and
play back the obtained content.

3. The content processing system according to claim 2, wherein
the information relating to the internal space of the moving body is arrangement information of at least one device arranged in the internal space of the moving body,
the content generating device is further configured to:
obtain information relating to a type of the at least one device; and
generate the content on a basis of the arrangement information of the at least one device, the information relating to the passenger, the information relating to traveling, and the information relating to the type of the at least one device, and
the content playback device is further configured to:
obtain the information relating to the type of the at least one device;
obtain, from the storage device, content corresponding to the arrangement information of the at least one device, the information relating to the passenger, the information relating to traveling, and the information relating to the type of the at least one device; and
play back the obtained content with use of the at least one device.

4. The content processing system according to claim 1, wherein
the content generating device is further configured to:
generate pieces of content for respective given ranges; and
store, in the storage device, the pieces of content for the respective given ranges.

5. A content generating device comprising a processor,
the processor being configured to:
obtain information relating to an internal space of an external moving body;
obtain information relating to traveling of the external moving body;
generate, on a basis of the information relating to the internal space and the information relating to traveling, content corresponding to a scene which changes as the external moving body travels; and
store the generated content in an external storage device.

6. A content playback device which is to be mounted on a moving body,
the content playback device comprising a processor,
the processor being configured to:
obtain information relating to an internal space of the moving body;
obtain information relating to traveling of the moving body;
obtain, from an external storage device, content corresponding to the information relating to the internal space and the information relating to traveling; and
play back the obtained content.
